(19) United States
(12) Patent Application Publication
(10) Pub. No.: US 2008/0260154 A1
(43) Pub. Date: Oct. 23, 2008

(54) METHOD AND SYSTEM FOR PROTECTING THE INTERNET ACCESS OF A MOBILE TELEPHONE, AND CORRESPONDING MOBILE TELEPHONE AND TERMINAL

(75) Inventors: Stephane Smierschalski, Paris (FR); Franck Chauvigne, Menilles (FR)

Correspondence Address: ARENT FOX LLP, 1050 CONNECTICUT AVENUE, N.W., SUITE 400, WASHINGTON, DC, 20036, US

(73) Assignee: BOUYGUES TELECOM, BOULOGNE-BILLANCOURT (FR)

(21) Appl. No.: 12/105,842

(22) Filed: Apr. 18, 2008

(30) Foreign Application Priority Data
Apr. 19, 2007 (FR) 0754578

(51) Int. Cl. H04L 9/00

(52) U.S. Cl. 380/270

(57) ABSTRACT

SIM cards of mobile telephones contain an identification code for having access to the Internet. However, such cards can be removed from the mobile telephone which they are normally provided for, in order to be inserted into other mobile telephones, smartphones or on the PCMCIA card of a PC.

The invention aims at protecting the access to the Internet of such mobile telephones. For this purpose, a particular code (K) is implemented on the memory (100) of the mobile telephone (1). An Internet browser then makes it possible to communicate this model code, after the ciphering thereof, to the Internet gateway (3) of its network operator. The ciphering provides dynamic information specific to each connection request. Each request sent to a content provider (15) contains the ciphered model code in its header. The gateway (3) deciphers said model code, to check whether it is recognised and informs the content provider (15) prompted by the request, whether the terminal is authorised or unknown. The particular Internet browser can also be used for indicating the gateway (3), what the browsing type desired by the terminal is, a simple or full-browsing, for differentiated pricing purposes.

The invention relates to a method and a system for protecting the Internet connection of telephones of a mobile operator for consulting the services and the electronic messaging services. It also relates to mobile telephones as well as the video on demand terminals implementing such method.

At present, the SIM cards provided in mobile telephones enable the user of a mobile telephone to browse the Internet via the mobile operator's network or networks, which he subscribed to. For this purpose, the Internet sites have a usability and contents developed according to the various browsing technologies of the mobile telephone on the Internet network (browsers such as for example i-mode, WAP, Full-Browsing, etc.).

However, there exists a problem as regards the identification of the equipment used for the connection. The identification of the equipment is the only guarantee that the correct content has been delivered to the correct mobile (a content adapted to the equipment, an appropriate protection level of the content according to the equipment).

A first security level existing consists in checking that the access authorisation is contractually linked to the telephone SIM card, and thus makes it possible to open the points of access to the operator's network authorised by the contract.

Besides, in order to identify the mobile telephone by a “name” with the mobile telephone operator thereof, a parameter of the browser is incorporated in the telephone, the “User-Agent” which makes it possible to identify the model of the telephone requesting an Internet connection. Such identification can be checked by a filtering on the operator's network access gateway.

Besides, on some telephone categories, it is possible to reject some connections if the phone is used as a modem. This makes it possible to limit the access to some access points of the operator to the telephone applications only.

In order to limit the access to the networks of the authorised browsers, the patent document US 20040059937 provides the reduction of the access to a content in a central server to a limited number of browsers identified by an identifier transmitted in a request.

In the patent document WO 2006106270, it is provided to store the utilisation rights in the SIM card of the mobile. The mobile generates ciphering/deciphering keys for transferring a thus protected multimedia content to the mobile.

Other techniques implement an architecture specific to an authentication. For example, the document WO 2005041608 uses a server dedicated to the authentication by means of an electronic signature.

The current issue in the present technique results from the fact that the SIM cards can be removed from the mobile telephone, which they are normally provided for, so as to be inserted into other mobile telephones, smartphones or the PCMCIA card of a PC.

As regards the identification of the “User-Agent” type, the “name” can be changed on most PCs or smartphones browsers, by borrowing the “name” of another network browser (such names being very simple and easily available).

As regards the restriction of certain access points of the operator during the utilisation of the phone as a modem, some mobiles only execute such checking. Most mobiles do not execute such checking and thus, it is easy to use a point of access of the operator reserved to telephones only by replacing the mobile executing the checking of the modem utilisation by a mobile which does not execute this checking to connect a computer via a telephone.

Consequently, during a connection to the Internet, the mobile operator has no means to make the distinction in a certain way, from its network, between one of its subscribers' telephone, and a computer, another telephone or a smartphone. The information supplied by such Internet connections can thus be communicated to other users or devices than the mobile operator's clients using the equipment identified by the identification application. As a matter of fact, the identification of a computer or another telephone can be easily replaced by an identification recognised as being that of one of the mobile operator's clients authorised to browse the Internet.

The existing safety measures do not make it possible for one mobile telephone operator to check the identity of the user of the Internet connection: as a matter of fact, they concern the identification by the operator of the SIM card, or an application of a “User-Agent” type incorporated in the telephone. Thus, when the User Agents are identical, it is impossible to make the distinction between the “Full-Browsing” browsers, and the i-mode or WAP browsers and thus to differentiate the pricing, adapt the content or increase the security thereof.

The present invention aims at solving such identification of the clients' issue by a mobile telephone operator, thanks to means making it possible to identify the mobile telephone and not the SIM card.

More precisely, the object of the invention is a method for protecting the Internet connection of a mobile telephone by a gateway of an operator's network, wherein an identification model code stored in the telephone is ciphered, transmitted as a header of each connection request, identified by the deciphering and validated on the Internet access gateway.

According to particular embodiments:
the model code stored is specific to a series, a model or a batch of mobile telephones;
the ciphering consists in ciphering the model code by dynamic information which characterise the current communication such as the date and time, the IP address of the mobile, the IP address of the gateway, the identification of the operator's network access point (APN) that the mobile telephone is trying to connect to, the name of the mobile and/or the size of the request. As the model code obtained varies over time, it will thus be all the more difficult to decipher it in the case of an interception;
the gateway deciphers the model code transmitted by the telephone and checks the validity thereof by filtering. Further to such checking, if the model code is known, the mobile will then be declared as an “authorised terminal”. The gateway then defines its profile of utilisation of the Internet services according to the browsing mode authorised by interrogating its database;
the result of the filtering, which makes it possible to make the distinction between the authorised and the non-authorised mobiles and the profile of utilisation replace the model code in an indication transmitted to the content providers:
if the code is known, the mobile is declared as an authorised terminal with such providers and if the code is unknown or considered by the database as uncertain, for example, in the case of models code made accessible to the public, embezzled (when the modem model code is found out), incompatible or unavailable (for older mobiles), the mobile telephone is declared as an “unknown”, “uncertain”, “embezzled” or “unavailable” terminal with the Internet content providers;
the Internet connection of an “unknown terminal” enables the Internet content providers to adapt the content of the delivered information as a function of the profile of the (known or unknown) terminal determined by the gateway;
the requested mode of browsing on the Internet is supplied to the operator for pricing purposes: such pricing can be different, depending on the desired browser: restricted (for example: i-mode or WAP) technology or a more elaborate (for example full-browsing) technology.

The invention also relates to a system for protecting the Internet access of a mobile telephone for implementing the previous method, such telephone having a digital data managing module (DRM). Such system includes an application for ciphering the stored model code integrated in the DRM, such application being implemented upon each transmission of a request on a deciphering application incorporated on the Internet network (IN) access gateway.

According to particular embodiments:
the ciphering application is incorporated in a memory of the mobile telephone, and a transmitted or received data compression or decompression memory;
the deciphering application also checks the conformity of the model code with respect to the database thereof and interprets such conformity in order to transmit a message to the content providers on the client profile of the mobile telephone, more particularly selected among an authorised, incompatible, unknown and embezzled mobile;
a “full-browsing” option is also provided on the telephones in order to make the distinction between the browsing types and to execute the corresponding pricing; when the browser selects this option, it is communicated to the operator by the ciphering application of the mobile telephone.

Other characteristics and advantages of the invention will appear upon reading the following description of a non-limitative exemplary embodiment and referring to the appended drawings, which show respectively:

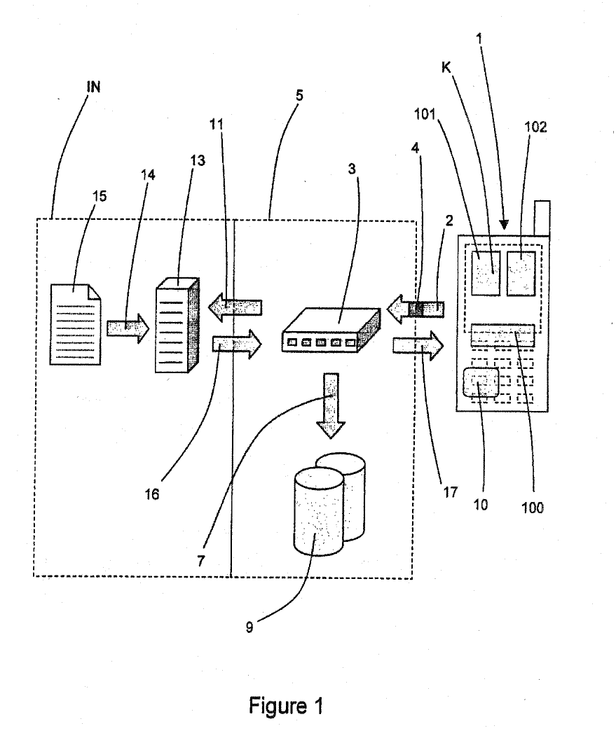

FIG. 1, a schematic view of a mobile telephone connection to the Internet network via its mobile operator's network within the protected scope of the invention; and

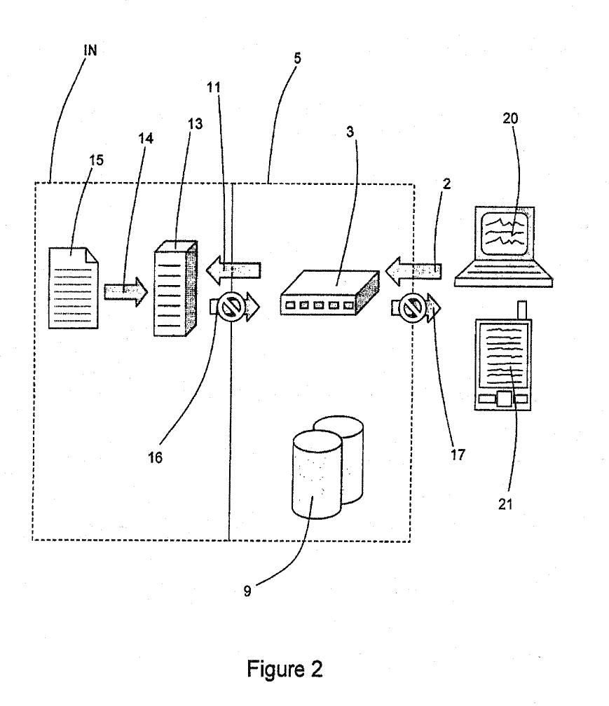

FIG. 2, a non-authorised module trying to connect to the Internet through a SIM card within the protected scope according to the invention.

Referring to FIG. 1, the mobile telephone 1 shown is more particularly provided with a SIM card 10 giving access to the Internet, a digital module 100 or DRM, for managing the emission/reception of data in packets, with data memorisation/decompression modules 101 and data compression/memorisation modules 102. A model code K identifying the telephone model is memorised in the mobile data decompression memory 101. While preparing the emission of a request 2 for access to the Internet network IN, a ciphering of the model code is executed by a DRM application incorporated in the mobile managing digital module 100. Such management module has the thus ciphered model code in the header of the request to form an identification signature of this mobile. In the case shown, the mobile operator provides the Internet services through the browser, the gateway to the services is called Proxy and the corresponding DRM application is called Proxy DRM.

In this exemplary embodiment, the header is formed of a sequence consisting of the IP addresses of the mobile and the Proxy gateway to the operator's network, the date and time of the emission of the request, as well as the IP address of the network access point (known as APN) and the model code for identifying the mobile.

The request 2, together with its signature, is then transmitted as a header to the Proxy network gateway 3 of its operator after having passed the access point PNA 4 to the network 5 of the operator.

The gateway 3 deciphers the header, then filters the access by checking that the model code is valid for the browser used and the requested services. The filtering is executed by an interrogation (arrow 7) to the database 9 thereof. If the answer is positive, as in this example, the gateway 3 sends a message 11 to the Internet server 13 concerned by the request. The message contains the “authorised terminal” information in this example, as well as the request for the downloading of data to the content 15 provider. The provider's data 15 are then retrieved on the reverse path via the connection 14 up to the server 13, the link 16 up to the gateway 3, then the link 17 up to the mobile data 1. The data are then finally memorised after compression in the module 102.

Depending on the result of the comparison between the model code of the mobile and those of the database 9 of the gateway 3, a message adapted to the profile of the mobile is transmitted to the Internet servers. Advantageously, a profile parameter makes it possible or not to activate the filtering function. The operators having no compatible gateway can deactivate the filter. The browser which appears as an unknown mobile (refer hereinunder) can also deactivate the filter.

The message contains information complying with such comparison: “protected terminal” as in the example above, “unknown terminal” if the code is uncertain, incomplete or unavailable, “embezzled terminal” if a modem type code is identified or eventually “incompatible terminal” for the mobiles of the prior generation. The servers which receive messages other than “authorized terminal” can lock the access to the data provider, start an overpricing or send a return message. An example of treatment is shown hereinafter, while referring to FIG. 2.

In FIG. 2, a PC 20 or a smartphone 21 without the ciphering application, which uses a SIM card for its connection to the Internet sends to the Proxy gateway 3 a request 2 for a connection to the Internet. It registers by means of the information contained in the SIM card, via a “user-agent”.

But the Proxy gateway 3 does not detect a model code and the consultation of the database 9 is not executed in this example. In an alternative embodiment, the gateway can optionally consult its database in order to finalise the applicant's profile and transmit a more precise message to the Internet server.

In the illustrated example, a message sent by the gateway to the Internet server 13 concerned by the request contains the “unknown terminal” information, as well as a request for downloading data from the content provider 15, subject to an approval. In the case shown, the Internet server 13 decides not to transfer the information requested to the terminals 20 or 21. The Internet server 13 then sends a rejection message 16, which is relayed by the Proxy gateway 3 and the link 17 up to the terminals 20 or 21.

The invention is not limited to the case of mobile telephones only. It can also be applied to mobile operators and to cable operators, whose clients purchase time for images, films or television programs, generally called “video on demand” (or VOD), and the terminals of the clients, computers, decoders or television sets then have the same identification system, according to the invention, as those of the mobile telephones.

1. A method for protecting the Internet connection of a mobile telephone by a gateway of an operator's network, characterised in that an identification model code (K) stored in the telephone (1) itself is ciphered, transmitted as a header of each connection request, identified by deciphering and validated on the Internet access gateway (3).

2. A protection method according to claim 1, characterised in that the stored model code is specific to a series, to a model or to a batch of mobile telephones.

3. A protection method according to claim 1 or 2, characterised in that the ciphering comprises ciphering the model code by means of dynamic information which characterise the current communication.

4. A protection method according to claim 3, characterised in that the ciphering dynamic information are selected among the date and time, the IP address of the mobile, the IP address of the gateway, the identification of the operator's network access point, the name of the mobile and the size of the request.

5. A protection method according to claim 1 or 2, characterised in that the gateway (3) deciphers the model code transmitted by the telephone (1), checks the validity thereof by filtering, then, if the mobile is authorised, defines its utilisation profile of the Internet services according to the authorised browsing mode by interrogating its database (9).

6. A protection method according to claim 5, characterised in that the filtering, which consists in making a distinction between the authorised and non-authorised mobiles, and the utilisation profile replace the model code in an indication transmitted to the content providers (15).

7. A protection method according to claim 6, characterised in that, if the model code is known, the mobile (1) is then declared as an “authorised terminal” with such providers (15), and if the code is unknown or considered by the database as uncertain, embezzled or incompatible, the mobile telephone is declared as an unknown, uncertain, embezzled terminal or incompatible with the Internet content providers.

8. A protection method according to claim 7, characterised in that the Internet connection of an “unknown terminal” makes it possible for the Internet content providers (15) to adapt the content of their information delivery as a function of the profile of the terminal determined by the gateway (3).

9. A protection method according to claim 8, characterised in that the requested browsing mode on the Internet is supplied to the operator for pricing purposes according to the desired or authorised browsing mode.

10. A system for protecting the Internet access of a mobile telephone, the telephone (1) having a DRM data managing module (100) which includes an application for ciphering a stored model code (K) integrated in the DRM, such application being implemented upon each transmission of a request on a deciphering application incorporated in a Internet network (IN) access gateway (3).

11. A protection system according to claim 10, characterised in that the ciphering application is incorporated in a memory of the mobile telephone, a transmitted or received data compression memory (101) or decompression memory (102).

12. A protection system according to claim 11, characterised in that the deciphering application also checks the conformity of the model code (K) with respect to the data base thereof and interprets such conformity in order to transmit a message to the content providers on the client profile of the mobile telephone, selected among an authorised, incompatible, unknown and embezzled mobile.

13. A protection system according to any one of claims 10 to 12, characterised in that a “full-browsing” option is provided to the telephones (1) in order to make the distinction between the browsing types and to execute the corresponding pricing and in that, in case of utilisation, such option is communicated to the operator by the mobile telephone ciphering application.

14. A mobile telephone, characterised in that a model code (K) is stored and ciphered in the telephone, and in that it is provided with a browser making it possible to transmit to the Internet network (IN) access gateway (3) according to claim 1 or 10.

15. A video on demand terminal (VOD) provided with a browser and a memory integrating a model code, which can be ciphered and transmitted to the Internet network (IN) access gateway (3) according to claim 1 or 10.
